(19) United States
(12) Patent Application Publication
(10) Pub. No.: US 2012/0235520 A1
(43) Pub. Date: Sep. 20, 2012

(54) HAND TOOL

(75) Inventor: Helmut BURGER, Prittriching (DE)

(73) Assignee: Hilti Aktiengesellschaft, Schaan (LI)

(21) Appl. No.: 13/420,353

(22) Filed: Mar. 14, 2012

(30) Foreign Application Priority Data
Mar. 16, 2011 (DE) 10 2011 005 593.2

(51) Int. Cl. H02K 7/14

(52) U.S. Cl. 310/50

(57) ABSTRACT

A hand tool is disclosed. A polarity reversing switch has first contact devices which are immovable with respect to a machine housing and second contact devices on a brush holder. An operating element is adjustable between two positions for changing a direction of travel of an electric motor. At least one of the first contact devices has a first metal strip and a first spring. A section of the first metal strip has a first contact face for contacting one of the second contact devices. The first spring is prestressed in the direction toward the second contact device. At least one of the second contact devices has a second metal strip and a second spring. A section of the second metal strip has a second contact face for contacting one of the first contact devices. The second spring is prestressed in the direction of the first contact device.

This application claims the priority of German Patent Document No. DE 10 2011 005 593.2, filed Mar. 16, 2011, the disclosure of which is expressly incorporated by reference herein.

### BACKGROUND AND SUMMARY OF THE INVENTION

The present invention relates to a hand tool for a rotating tool. The direction of rotation of the tool can be set by an operating element on the hand tool.

The hand tool according to the invention has a machine housing, in which an electric motor is arranged, having a brush holder that can be pivoted about a motor axis. A polarity reversing switch of the hand tool has first contact devices which are immovable with respect to the machine housing and second contact devices arranged on the brush holder. An operating element is adjustable by a user between two positions, so that the brush holder is pivoted to change the direction of rotation of the electric motor. Two stationary first contact devices and three or more pivotable second contact devices are provided, for example. The first contact devices come in contact with others of the second contact devices, depending on the position of the brush holder. At least one of the first contact devices has a first metal strip and a first spring, preferably being separate. A section of the first metal strip has a first contact face on one side for contacting one of the second contact devices, and the first spring is prestressed in the direction of the second contact device against one side of the section of the first metal strip opposite the first contact face. At least one of the second contact devices has a second metal strip and a second spring, such that a section of the second metal strip has a second contact face on one side for contacting one of the first contact devices and the second spring is prestressed in the direction of the first contact device against one side of the section of the second metal strip opposite the second contact face. The metal strip forms the electric contact and part of a rewiring, which carries current to the electric motor. The metal strip is preferably made of copper. The spring, which is not involved in the rewiring, may be optimally designed for a spring force.

According to one embodiment, another section of the first metal strip is permanently connected to a power supply of the hand tool, and/or another section of the second metal strip is permanently connected to a brush device on the brush holder. One strand may be soldered, welded or clamped to the other section of the first metal strip and/or the other section of the second metal strip. A current is supplied into a strand through the one section and the other section.

According to one embodiment, the first spring and/or the second spring is/are currentless, i.e., no current flows through the springs. The springs contact the metal strip at only one end, while another end of the springs preferably contacts an insulating carrier that is insulated from the metal strip. The first spring may be clamped between the side of the first metal strip opposite the first contact face and a first electrically insulating carrier, and/or the second spring may be clamped between the side of the second metal strip opposite the second contact face and the second electrically insulating carrier.

According to one embodiment, the first metal strip is guided in a first slide way parallel to the direction of the second contact device, and/or the second metal strip is guided in a second slide way parallel to the direction of the first contact device. A section of the first metal strip arranged in the first slide way may be bent at an angle to the section with the first contact face, and/or a section of the second metal strip arranged in the second slide way may be bent at an angle to the section with the second contact face.

According to one embodiment, the first metal strip, between the section with the first contact face and a section to which a strand is soldered, welded or clamped, has another section which is arranged in the first slide way, and/or the second metal strip, between the section with the second contact face and a section to which a strand is soldered, welded or clamped, has another section which is arranged in the second slide way.

The following description explains the invention on the basis of exemplary embodiments and figures.

### BRIEF DESCRIPTION OF THE DRAWINGS

FIG. 1 shows a hand tool;

FIG. 2 shows a brush plate;

FIGS. 3, 4 and 5 show a motor with the brush plate in various longitudinal sections;

FIGS. 6 and 7 show detailed views of the brush plate; and

FIG. 8 shows another motor.

### DETAILED DESCRIPTION OF THE DRAWINGS

The same elements or elements having the same function are indicated by the same reference numerals in the figures unless otherwise indicated.

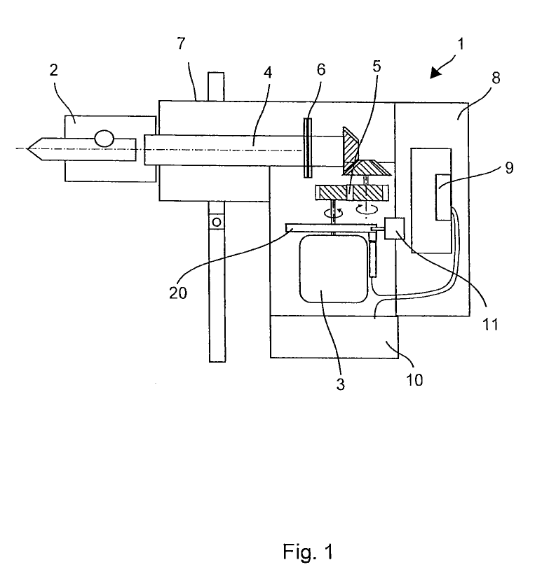

FIG. 1 shows a hammer drill 1 schematically as an example of a hand tool. The hammer drill 1 has a tool receptacle 2, into which a drill bit or another rotary tool, e.g., a drill, may be inserted. An electric motor 3 drives the tool receptacle 2 and thus rotates the tool about its axis. A drive train 4 between the electric motor 3 and the tool receptacle 2 may contain a gear 5 and a clutch 6, among other things. The electric motor 3 and the drive train 4 are arranged in a machine housing 7, which a user can guide by a handle 8. A main switch 9 allows the user to turn the hammer drill 1 on and off via the electric motor 3. The main switch 9 may close or interrupt a current supply from a current source 10, for example, a battery or a line connection to the electric motor 3. The user can change the direction of rotation of the electric motor 3 by a mechanical control mechanism 11, such as a lever.

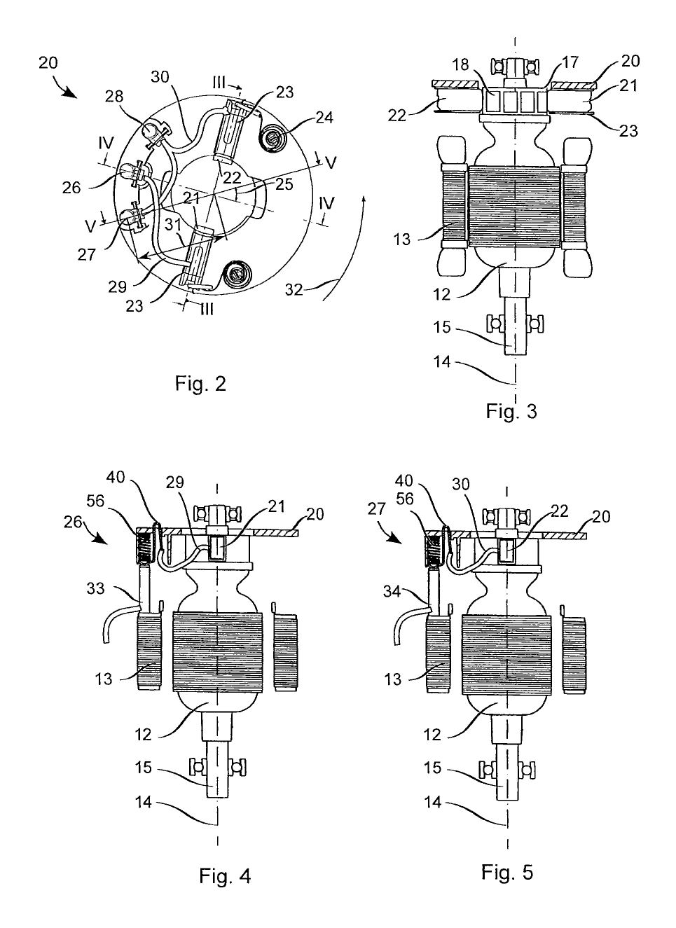

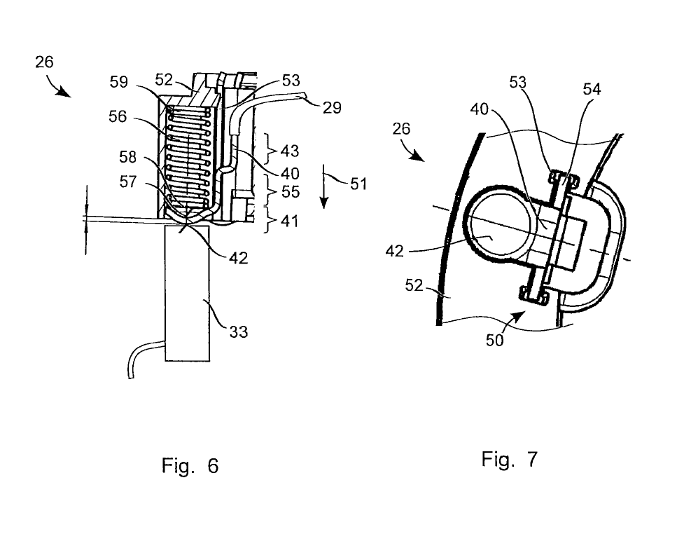

FIGS. 3, 4 and 5 show the electric motor 3 in a longitudinal section in planes and IV-IV and V-V which are shown in FIG. 2. Detailed views are shown in FIGS. 6 and 7. The electric motor 3 has a rotor 12 which is mounted inside a stator 13 to rotate about a motor axis 14. A shaft 15 of the rotor 12 has multiple coil windings which can be supplied with current via a loop ring 17 mounted on the shaft 15. The loop ring 17 has several mutually insulated contact sections 18 following one another along its circumference, and permanently electrically connected to the coil windings, for example, by soldering or clamp connections.

A brush holder 20 contacts the rotating loop ring 17. The exemplary brush holder 20 has a first carbon brush 21 and a second carbon brush 22, both of which are prestressed radially against the contact sections 18 of the loop ring 17 to ensure an electrical contact between the carbon brushes 21, 22 and the contact sections 18 rotating with respect to the carbon brushes 21, 22. The carbon brushes 21, 22 are each arranged in a carbon guide 23, for example, which guides the carbon brushes 21, 22 radially. The prestress may be provided by a spiral spring 24, for example.

The brush holder 20 can be pivoted between two positions about the motor axis 14 by an adjustment angle 25 by the control mechanism 11. Electric current is fed into the carbon brushes 21, 22 via three terminal contacts 26, 27, 28 to the brush holder 20. The first carbon brush 21 is electrically connected to the first terminal contact 26, for example, by a strand 29. The second carbon brush 22 is connected to the second terminal contact 27 and to the third terminal contact 28, for example, by additional strands 30. The three terminal contacts 26, 27, 28 are preferably arranged at the same radial distance 31 from the motor axis 14. The first terminal contact 26 is arranged with an offset in the circumferential direction 32 about the motor axis 14 between the second terminal contact 27 and the third terminal contact 28 and is offset by the adjusting angle 25 relatively to the second terminal contact 27 and the third terminal contact 28.

The electric motor 3 has two feed contacts 33, 34 which are stationary with respect to the stator 13 and the machine housing 7 and by means of which electric current can be fed into the terminal contacts 26, 27, 28. The feed contacts 33, 34 are permanently connected electrically and mechanically to the power supply of the hammer drill 1. The two feed contacts 33, 34 are arranged at the same radial distance 31 from the motor axis 14 as the terminal contacts 26, 27, 28 and are offset by the adjusting angle 25 about the motor axis 14 in relation to one another. In a first pivot position of the brush plate 20, the first terminal contact 26 touches the first feed contact 33 and the second terminal contact 27 touches the second feed contact 34 (FIGS. 4 and 5). In a second pivot position of the brush plate 20, the first terminal contact 26 touches the second feed contact 34 and the third terminal contact 28 touches the first feed contact 33. By pivoting the brush holder 20 about the adjustment angle 25, the direction of current flow through the electric motor 4 is reversed.

The structure of the three terminal contacts 26, 27, 28 is preferably the same, which is why the first terminal contact 26 which contacts the first feed contact 33 in the position of the brush holder 20 shown here is described below as an example.

The terminal contact 26 has a metal strip 40 which has a contact face 42 for contacting the feed contact 33 in a first section 41. A second section 43 of the metal strip 40 is permanently connected electrically and mechanically to the strand 29, e.g., by soldering, welding or clamping. The strand 29 is permanently connected electrically to the first carbon brush 21. An electrical current flows through the feed contact 33, over the contact face 42 into the metal strip 40, out of the second section 43 over the strand 29 and into the first carbon brush 21. The electric contact between the feed contact 33 and the contact face 42 may be opened and closed by pivoting the brush holder 20 and the additional electric connections are permanent in the sense that only destructive measures or measures which alter the hand tool 1 are able to interrupt the electric connections.

The metal strip 40 is guided in a slide bearing 50 along a guide direction 51. The guide direction 51 is preferably parallel to a direction from the terminal contact 26 to the feed contact 33, for example, parallel to the motor axis 14. The slide bearing 50 has, for example, a base body 52, in which longitudinal grooves 53 are created parallel to the guide direction 51. Longitudinal edges 54 of a third section 55 of the metal strip 40 engage in the longitudinal grooves 53. The metal strip 40 may be moved in the direction of the feed contact 33 by being guided through the longitudinal grooves 53. The third section 55 is preferably bent at an angle to the first section 41, for example, oriented at a right angle. The third section 55 may be arranged between the first section 41 and the second section 43 and has an electric current flowing through it.

The terminal contact 26 has a spring 56 which is separate from the metal strip 40. The spring 56 is in contact with a side 57 of the first section 41 opposite the contact face 42. The spring 56 is prestressed against the first section 41 of the metal strip 40 and presses the metal strip 40 against the feed contact 33 in the guide direction 51. The spring 56 is preferably made of a spring steel. A first end 58 of the spring 56 may come in contact with the metal strip 40. A second end 59 of the spring 56 is preferably supported on an insulating part of the brush carrier 20, for example, the base body 52 made of plastic. The spring 56 is therefore currentless, i.e., no electric current flows along the spring 56 from the first end 58 to the second end 59.

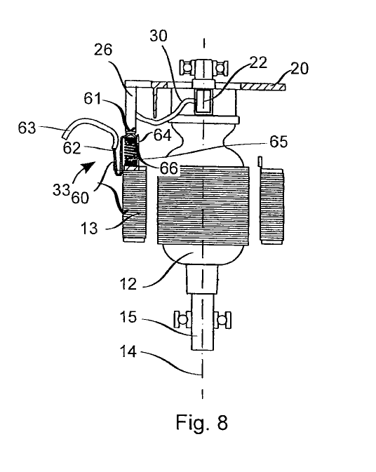

According to another embodiment, the stationary feed contact 33 is provided with a movable metal strip 60 (FIG. 8). A contact face 61 of the metal strip 60 may come in contact with the terminal contact 26 of the brush holder 20 and may electrically contact it. A terminal lug 62 is provided on the metal strip 60 with a strand 63 permanently connected to the lug, e.g., by soldering, welding or clamping. The strand 63 is directly or indirectly connected to the power supply 10. The metal strip 60 is inserted into a guide 64 which limits movement of the metal strip 60 to a linear movement along one direction to the terminal contact 26, e.g., parallel to the motor axis 14. A separate spring 65 is prestressed against a side 66 of the metal strip 60 opposite the contact face 61. Because of the spring 65, the metal strip 60 is pressed against the terminal contact 26. In one embodiment the feed contacts and the terminal contacts are provided with a metal strip which is prestressed by a spring and is guided along one direction.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A hand tool, comprising:
a machine housing;
an electric motor including a brush holder that is pivotable about a motor axis and a polarity reversing switch that includes first contact devices which are immovable with respect to the machine housing and second contact devices which are disposed on the brush holder; and
an operating element coupled to the brush holder;
wherein at least one of the first contact devices has a first metal strip and a first spring, wherein a first section of the first metal strip has a first contact face that is contactable with at least one of the second contact devices, and
wherein the first spring is prestressed against the first section of the first metal strip in a direction toward the second contact devices; and/or wherein at least one of the second contact devices has a second metal strip and a second spring, wherein a first section of the second metal strip has a second contact face that is contactable with at least one of the first contact devices, and wherein the second spring is prestressed against the first section of the second metal strip in a direction toward the first contact devices.

2. The hand tool according to claim 1, wherein a second section of the second metal strip is permanently connected to a brush device on the brush holder.

3. The hand tool according to claim 1, wherein a second section of the first metal strip is permanently connected to a power supply.

4. The hand tool according to claim 2, further comprising a strand that is soldered, welded or clamped to the second section of the second metal strip.

5. The hand tool according to claim 3, further comprising a strand that is soldered, welded or clamped to the second section of the first metal strip.

6. The hand tool according to claim 1, wherein the first spring and/or the second spring is/are currentless.

7. The hand tool according to claim 6, wherein the first spring is clamped between the first section of the first metal strip and a first electrically insulating carrier and/or the second spring is clamped between the first section of the second metal strip and a second electrically insulating carrier.

8. The hand tool according to claim 1, wherein the first metal strip is guided in a first slide way parallel to the motor axis and/or the second metal strip is guided in a second slide way parallel to the motor axis.

9. The hand tool according to claim 8, wherein a portion of the first metal strip is disposed in the first slide way and is bent at an angle to the first section of the first metal strip and/or a portion of the second metal strip is disposed in the second slide way and is bent at an angle to the first section of the second metal strip.

10. The hand tool according to claim 8, wherein a portion of the first metal strip, between the first section of the first metal strip and a second section of the first metal strip to which a strand is soldered, welded or clamped, is disposed in the first slide way and/or wherein a portion of the second metal strip, between the first section of the second metal strip and a second section of the second metal strip to which a strand is soldered, welded or clamped, is disposed in the second slide way.
